(19) United States
(12) Patent Application Publication
(10) Pub. No.: US 2026/0167779 A1
(43) Pub. Date: Jun. 18, 2026

(54) METHOD FOR PREPARING WATER-SOLUBLE EPOXY RESIN CARBON FIBER SIZING AGENT

(71) Applicant: Jilin University of Chemical Technology, Jilin (CN)

(72) Inventors: Shulai Lu, Jilin (CN); Jingfu Dai, Jilin (CN); Jianzhuo Li, Jilin (CN); Xiaokun Ma, Jilin (CN); Bangqiong Song, Jilin (CN); Naiqing Liu, Jilin (CN)

(21) Appl. No.: 19/534,808

(22) Filed: Feb. 10, 2026

Related U.S. Application Data
(63) Continuation of application No. PCT/CN2024/097911, filed on Jun. 7, 2024.

(30) Foreign Application Priority Data
Aug. 11, 2023 (CN) 2023110116075

(51) Int. Cl. C08G 81/02; C08F 283/06; C08G 59/02; C08G 65/30; D06M 15/53; D06M 15/55; D06M 101/40

(52) U.S. Cl. CPC C08G 81/025; C08F 283/06; C08G 59/02; C08G 65/30; D06M 15/53; D06M 15/55; D06M 2101/40; D06M 2200/40; D10B 2101/12

(57) ABSTRACT

A method for preparing a water-soluble epoxy resin carbon fiber sizing agent is provided, belonging to the field of sizing agents. One end of the sizing agent is a hydrolyzable group, which can bind to a hydroxyl group (—OH) on a carbon fiber surface; the other end is a non-hydrolyzable group capable of reacting with a resin matrix. In this situation, functional groups from the sizing agent are introduced onto the carbon fiber surface, increasing the surface activity of the carbon fiber and consequently enhancing the chemical bonding between the carbon fiber and the resin matrix. Moreover, the sizing agent possesses excellent self-emulsifying capability, overcoming the stability issues associated with emulsion-type sizing agents. This self-emulsifying epoxy resin sizing agent is highly safe, environmentally friendly, convenient to use, and can be emulsified and used at a time selected according to processing requirements.

### TECHNICAL FIELD

The disclosure relates to the technical field of sizing agents, and more particularly to a method for preparing a water-soluble epoxy resin carbon fiber sizing agent.

### BACKGROUND

Carbon fiber composites have been widely recognized for their various excellent properties. However, their widespread adoption is primarily limited by the quality and cost of carbon fibers, as well as the performance stability of the carbon fiber composites. This is mainly because the carbon fibers are subjected to friction and wear during subsequent processing, generating fuzz or broken filaments, which not only hinders the smooth progress of downstream processes but also degrades the overall performance of the carbon fibers. Therefore, sizing treatment of the carbon fibers is necessary.

A sizing agent is a layer of chemical coating applied to the fiber surface, and the sizing process is an essential step in carbon fiber production. The functionality of the sizing agent is mainly reflected in the following aspects. Firstly, the sizing agent protects the carbon fiber surface, preventing damage during winding, packaging, and transportation; and the sizing agent also isolates the carbon fibers from air, preventing the adsorption of dust and moisture from the environment onto the carbon fiber surface. Secondly, the sizing agent can effectively improve the bundling properties of the carbon fibers, acting like an adhesive to hold the carbon fibers together, thereby improving processability and facilitating handling. Furthermore, similar to a coupling agent, the sizing agent can fill surface defects on the carbon fibers, improve the chemical bonding between the carbon fibers and resin, enhance the mechanical properties of the composites, reduce composite preparation time, and improve product quality. Therefore, developing high-performance carbon fiber sizing agents is of positive significance for improving carbon fiber quality and composite performance. In contrast, simple emulsion-type sizing agents are typically composed of two immiscible liquids that are combined through the addition of other surfactants to achieve a temporary blend. However, these emulsions generally exhibit poor stability. Over time, sedimentation or phase separation may occur, and demulsification can even take place during transportation. Moreover, existing sizing agents often exhibit poor interfacial adhesion, resulting in limited improvement in the mechanical properties of carbon fiber materials.

Therefore, how to provide a sizing agent with good stability, enhanced interfacial bonding with carbon fibers, and the ability to improve carbon fiber strength is a problem urgently needing resolution by those skilled in the art.

### SUMMARY

In order to overcome the shortcomings and deficiencies of the related art, the disclosure provides a method for preparing a water-soluble epoxy resin carbon fiber sizing agent. The sizing agent possesses good self-emulsifying capability, overcoming the stability issues associated with emulsion-type sizing agents. Using phthalic anhydride-modified polyethylene glycol as a modifier, graft polymerization is performed with a formulated epoxy resin mixture, forming the water-soluble epoxy resin carbon fiber sizing agent capable of self-emulsification, featuring a hydrophobic epoxy end and a hydrophilic modified polyethylene glycol end. This structure enhances the interfacial bonding between the carbon fiber and the epoxy resin.

To achieve the above objective, the disclosure adopts the following technical solutions.

Specifically, a method for preparing a water-soluble epoxy resin carbon fiber sizing agent, including the following steps:
(1) subjecting polyethylene glycol to vacuum distillation in a rotary evaporator to remove water molecules to obtain dehydrated polyethylene glycol;
(2) adding the dehydrated polyethylene glycol and phthalic anhydride into a reaction vessel, performing modification and grafting on the dehydrated polyethylene glycol in an acidic environment under stirring with condensate reflux, and introducing nitrogen for protection, thereby obtaining phthalic anhydride-modified polyethylene glycol;
(3) blending two different epoxy resins, calculating an epoxy equivalent weight to obtain a formulated epoxy resin mixture; and
(4) performing a grafting reaction between the phthalic anhydride-modified polyethylene glycol and the formulated epoxy resin mixture under an action of a catalyst, thereby obtaining the water-soluble epoxy resin carbon fiber sizing agent with a self-emulsifying capability.

In some embodiments, in step (1), the polyethylene glycol has a molecular weight in a range of 1000-4000.

In some embodiments, in step (2), a molar ratio of the phthalic anhydride to the polyethylene glycol is 1:(1.6-2.4).

In some embodiments, in step (2), the acidic environment has a pH in a range of 3-5; and a speed of the stirring is in a range of 180-300 revolutions per minute (r/min).

Beneficial effects of the above-mentioned technical solutions are as follows. A stirring speed that is too high is not conducive to polymerization, while a stirring speed that is too low leads to poor dispersion and insufficient polymerization.

In some embodiments, in step (2), a reaction temperature of the modification and grafting is in a range of 105-140° C. and a reaction time of the modification and grafting is in a range of 2-4 hours.

In some embodiments, in step (3), the epoxy resins include E51 (i.e., Epoxy Resin E51, Bisphenol A-type epoxy resin), E44 (i.e., Epoxy Resin E44, Bisphenol A-type epoxy resin), 6004 (i.e., Epoxy Resin 6004, Tetrabromobisphenol A-based flame-retardant epoxy resin), and E414 (i.e., Epoxy Resin E414, Bisphenol A-type epoxy resin).

In some embodiments, in step (3), the formulated epoxy resin mixture has an epoxy equivalent weight in a range of 180-210.

The flexibility and heat resistance of a single epoxy resin cannot meet the requirements for preparing subsequent composite materials. The disclosure selects different epoxy resins for blending to endow the sizing agent with suitable softness and adhesion. The epoxy equivalent weight of the formulated epoxy resin mixture is estimated based on the epoxy equivalent weights and proportions of the selected different epoxy resins, which is then used to calculate a molar ratio of the formulated epoxy resin mixture to the phthalic anhydride-modified polyethylene glycol.

In some embodiments, in step (4), the molar ratio of the phthalic anhydride-modified polyethylene glycol to the formulated epoxy resin mixture is in a range of 1:(0.6-1.4).

In some embodiments, in step (4), the catalyst is one selected from potassium persulfate and ammonium persulfate.

In some embodiments, in step (4), a reaction temperature of the grafting reaction is in a range of 110-140° C. and a reaction time of the grafting reaction is in a range of 2-5 hours.

In the disclosure, the reaction equation for the phthalic anhydride-modified polyethylene glycol is as follows:

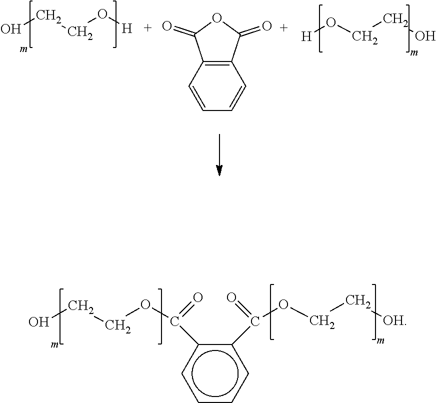

In the disclosure, the reaction equation between the phthalic anhydride-modified polyethylene glycol and the formulated epoxy resin mixture is as follows:

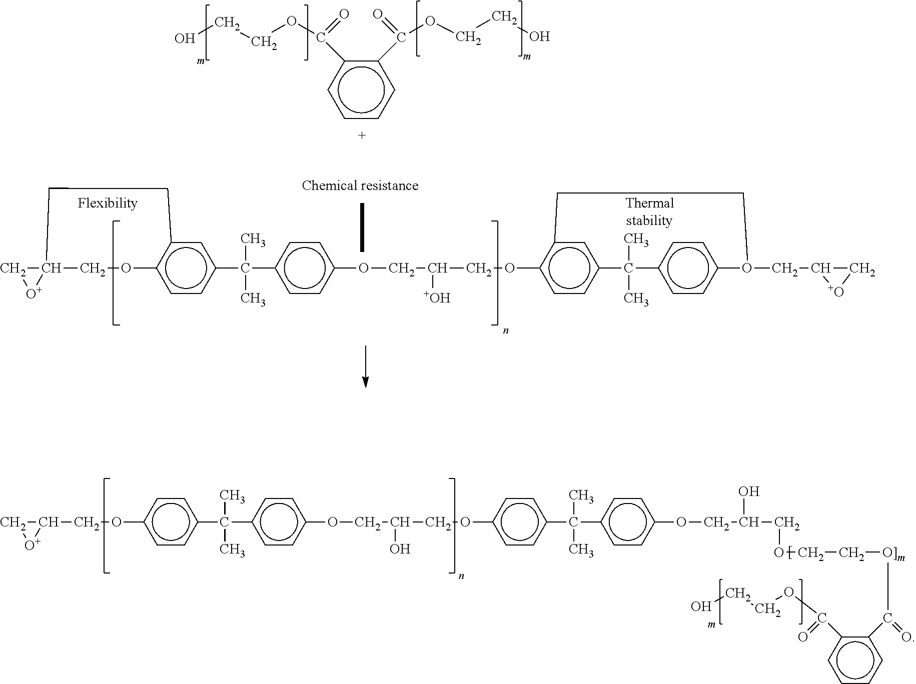

Based on the above technical solutions, compared with the related art, the disclosure provides the method for preparing the water-soluble epoxy resin carbon fiber sizing agent, having the following beneficial effects.

(1) The water-soluble epoxy resin carbon fiber sizing agent of the disclosure possesses good self-emulsifying capability, overcoming the stability problems of emulsion-type sizing agents. The blending of epoxy resins is employed to ensure the sizing agent has good adhesion and flexibility. Furthermore, one end of the sizing agent of the disclosure is a hydrolyzable group, which can bind to a hydroxyl group (—OH) on a carbon fiber surface; the other end is a non-hydrolyzable group capable of reacting with a resin matrix. In this situation, functional groups from the sizing agent are introduced onto the carbon fiber surface, increasing the surface activity of the carbon fiber and consequently enhancing the chemical bonding between the carbon fiber and the resin matrix.

(2) The disclosure utilizes phthalic anhydride-modified polyethylene glycol as the modifier for grafting with the epoxy resin. Due to the significant steric hindrance of the phthalic anhydride molecular structure, it ensures that the majority of reactions during the process with the epoxy resin proceed primarily via mono-end grafting. This is beneficial for efficiently preparing the water-soluble epoxy resin carbon fiber sizing agent with self-emulsifying properties, featuring one hydrophobic end and one hydrophilic end. This self-emulsifying epoxy resin sizing agent is highly safe, environmentally friendly, convenient to use, and can be emulsified and used at a time selected according to processing requirements.

### BRIEF DESCRIPTION OF DRAWINGS

To more clearly illustrate technical solutions in embodiments of the disclosure or in the related art, the following briefly introduces the accompanying drawings required for describing the embodiments or the related art. Apparently, the accompanying drawings in the following description merely illustrate some embodiments of the disclosure. For those skilled in the art, other drawings can be derived from the provided ones without making any creative effort.

FIG. 1 illustrates a diagram showing infrared spectra of various substances according to embodiment 2 of the disclosure, where a-polyethylene glycol 2000, b-formulated epoxy resin mixture, and c-water-soluble epoxy resin carbon fiber sizing agent.

FIG. 2 illustrates a scanning electron microscopy (SEM) photograph of a water-soluble epoxy resin carbon fiber sizing agent according to embodiment 4 of the disclosure.

FIG. 3 illustrates an SEM photograph of a surface of a carbon fiber sized with a water-soluble epoxy resin carbon fiber sizing agent according to embodiment 1 of the disclosure.

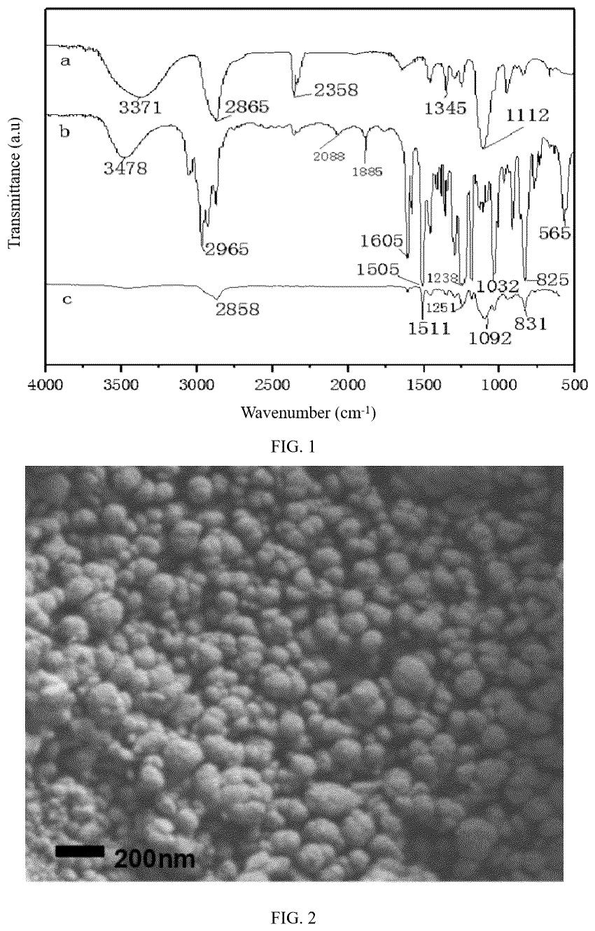

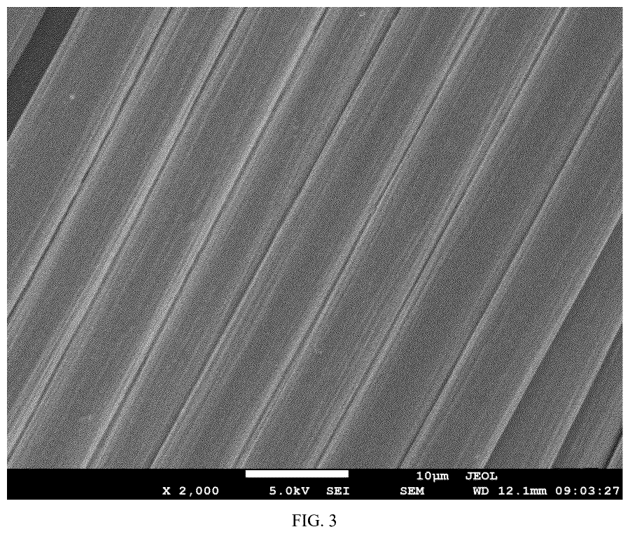

### DETAILED DESCRIPTION OF EMBODIMENTS

Technical solutions in the embodiments of the disclosure will be clearly and completely described below. It is apparent that the described embodiments are only a part of the embodiments of the disclosure, not all of them. Based on the embodiments of the disclosure, all other embodiments obtained by those skilled in the art without making creative efforts shall fall within the protection scope of the disclosure.

### Embodiment 1

Polyethylene glycol 1000 is weighed and subjected to vacuum distillation in a rotary evaporator to completely remove water molecules from the polyethylene glycol. Phthalic anhydride and polyethylene glycol are weighed in a molar ratio of 1:1.6 and then mixed to obtain a mixture. This mixture is added, under pH=4.0 conditions, into a four-neck separable glass reaction vessel equipped with a thermometer, a stirrer, a condenser for reflux, and a nitrogen inlet for protection, to perform modification and grafting of the polyethylene glycol. The reaction temperature is 115° C., and the reaction time is 2.5 hours.

Epoxy resins E51 and E414 are blended in a mass ratio of 2:1. Based on an epoxy equivalent weight of 190 for E51 and an epoxy equivalent weight of 220 for E414, the calculated epoxy equivalent weight of the formulated epoxy resin mixture is 200. The prepared phthalic anhydride-modified polyethylene glycol and the formulated epoxy resin mixture are combined in a molar ratio of 1:1. At 125° C., 0.1 grams (g) of potassium persulfate is added, and the reaction is carried out under nitrogen protection for 4 hours to obtain a water-soluble epoxy resin carbon fiber sizing agent.

### Embodiment 2

Polyethylene glycol 2000 is weighed and subjected to vacuum distillation in a rotary evaporator to completely remove water molecules from the polyethylene glycol. Phthalic anhydride and polyethylene glycol are weighed in a molar ratio of 1:2 and then mixed to obtain a mixture. This mixture is added, under pH=3.5 conditions, into a four-neck separable glass reaction vessel equipped with a thermometer, a stirrer, a condenser for reflux, and a nitrogen inlet for protection, to perform modification and grafting of the polyethylene glycol. The reaction temperature is 125° C., and the reaction time is 3 hours.

Epoxy resins E51 and 6004 are blended in a mass ratio of 1:1. Based on an epoxy equivalent weight of 190 for E51 and an epoxy equivalent weight 185 for 6004, the calculated epoxy equivalent weight of the formulated epoxy resin mixture is 187. The prepared phthalic anhydride-modified polyethylene glycol and the formulated epoxy resin mixture are combined in a molar ratio of 1:0.8. At 110° C., 0.1 g of potassium persulfate is added, and the reaction is carried out under nitrogen protection for 5 hours to obtain a water-soluble epoxy resin carbon fiber sizing agent.

### Embodiment 3

Polyethylene glycol 4000 is weighed and subjected to vacuum distillation in a rotary evaporator to completely remove water molecules from the polyethylene glycol. Phthalic anhydride and polyethylene glycol are weighed in a molar ratio of 1:1.8 and then mixed to obtain a mixture. This mixture is added, under pH=3.0 conditions, into a four-neck separable glass reaction vessel equipped with a thermometer, a stirrer, a condenser for reflux, and a nitrogen inlet for protection, to perform modification and grafting of the polyethylene glycol. The reaction temperature is 140° C., and the reaction time is 2 hours.

Epoxy resins E51 and E44 are blended in a mass ratio of 1:2. Based on an epoxy equivalent weight of 190 for E51 and an epoxy equivalent weight of 175 for E44, the calculated epoxy equivalent weight of the formulated epoxy resin mixture is 180. The prepared phthalic anhydride-modified polyethylene glycol and the formulated epoxy resin mixture are combined in a molar ratio of 1:0.6. At 140° C., 0.1 g of potassium persulfate is added, and the reaction is carried out under nitrogen protection for 4 hours to obtain a water-soluble epoxy resin carbon fiber sizing agent.

### Embodiment 4

Polyethylene glycol 1000 is weighed and subjected to vacuum distillation in a rotary evaporator to completely remove water molecules from the polyethylene glycol. Phthalic anhydride and polyethylene glycol are weighed in a molar ratio of 1:2.4 and then mixed to obtain a mixture. This mixture is added, under pH=4.5 conditions, into a four-neck separable glass reaction vessel equipped with a thermometer, a stirrer, a condenser for reflux, and a nitrogen inlet for protection, to perform modification and grafting of the polyethylene glycol. The reaction temperature is 105° C., and the reaction time is 4 hours.

Epoxy resins E51 and E414 are blended in a mass ratio of 1:2. Based on an epoxy equivalent weight of 190 for E51 and an epoxy equivalent weight of 220 for E414, the calculated epoxy equivalent weight of the formulated epoxy resin mixture is 210. The prepared phthalic anhydride-modified polyethylene glycol and the formulated epoxy resin mixture are combined in a molar ratio of 1:1.4. At 130° C., 0.1 g of potassium persulfate is added, and the reaction is carried out under nitrogen protection for 3 hours to obtain a water-soluble epoxy resin carbon fiber sizing agent.

### Embodiment 5

Polyethylene glycol 2000 is weighed and subjected to vacuum distillation in a rotary evaporator to completely remove water molecules from the polyethylene glycol. Phthalic anhydride and polyethylene glycol are weighed in a molar ratio of 1:2.2 and then mixed to obtain a mixture. This mixture is added, under pH=5.0 conditions, into a four-neck separable glass reaction vessel equipped with a thermometer, a stirrer, a condenser for reflux, and a nitrogen inlet for protection, to perform modification and grafting of the polyethylene glycol. The reaction temperature is 110° C., and the reaction time is 4 hours.

Epoxy resins 6004 and E414 are blended in a mass ratio of 3:1. Based on an epoxy equivalent weight of 185 for 6004 and an epoxy equivalent weight of 220 for E414, the calculated epoxy equivalent weight of the formulated epoxy resin mixture is 194. The prepared phthalic anhydride-modified polyethylene glycol and the formulated epoxy resin mixture are combined in a molar ratio of 1:1.2. At 120° C., 0.1 g of potassium persulfate is added, and the reaction is carried out under nitrogen protection for 3.5 hours to obtain a water-soluble epoxy resin carbon fiber sizing agent.

### Test Methods

A NanoBrook 90plus PALS laser particle size analyzer (Brookhaven Instruments, USA) is used to measure the particle size and Zeta potential of test samples. From the perspective of emulsion stability, emulsions with particle sizes in the range of 70-180 nanometers (nm) exhibit high stability and show no sedimentation after standing for 3-6 months. When the particle size is greater than 200 nm, the chance of mutual collision between particles increases, stability decreases, and partial sedimentation occurs after 3 months. Therefore, the optimal emulsion particle size is considered to be less than 180 nm. The Zeta potential test shows that all emulsions are negatively charged, with potential values in the range of −40 to −10 millivolts (mV). A larger absolute value of Zeta potential indicates more negative charge on the surface. Since all particles carry a negative charge, a larger surface charge results in greater repulsion between particles, thereby improving the stability of the emulsion system. Conversely, a smaller absolute Zeta potential leads to lower stability.

The mechanical stability of the water-soluble epoxy resin carbon fiber sizing agent is tested using a high-speed tabletop centrifuge (Model TGL-16B, Shanghai Anting Scientific Instrument Factory). For emulsions with particle size below 180 nm, no stratification is observed after centrifugation at 3000 r/min for 10 minutes, nor after low-speed centrifugation at 1000 r/min for 3 hours.

A field emission cryo-scanning electron microscope (Model JSM-7610F Plus, JEOL, Japan) is used. The emulsions of the water-soluble epoxy resin carbon fiber sizing agents from the embodiments are freeze-dried in liquid nitrogen respectively. The cross-section is cut open with a blade, coated with gold, and then examined to observe the sizing agent emulsion particles. It is observed that the obtained emulsion particles had a uniform morphology and spherical shape, with particle sizes close to the values measured by the laser particle size analyzer.

TABLE 1
Particle Size and Zeta Potential of the embodiments

| | Embodi- | Embodi- | Embodi- | Embodi- | Embodi- |
|---|---|---|---|---|---|
| | ment | ment | ment | ment | ment |
| | 1 | 2 | 3 | 4 | 5 |
| Particle | 79.59 | 125.05 | 147.20 | 136.28 | 117.44 |
| Size | | | | | |
| (nm) | | | | | |
| Zeta | −36.64 | −25.47 | −27.01 | −34.61 | −34.30 |
| Potential | | | | | |
| (mV) | | | | | |

TABLE 2
Mechanical Stability Test Results (1000 r/min)

| Centrifugation | | Emulsion model number | | | | |
|---|---|---|---|---|---|---|
| Time | | Embodiment 1 | Embodiment 2 | Embodiment 3 | Embodiment 4 | Embodiment 5 |
| 0.5 | h | No | No | No | No | No |
| | | stratification | stratification | stratification | stratification | stratification |
| 1 | h | No | No | No | No | No |
| | | stratification | stratification | stratification | stratification | stratification |
| 1.5 | h | No | No | No | No | No |
| | | stratification | stratification | stratification | stratification | stratification |
| 2 | h | No | No | No | No | No |
| | | stratification | stratification | stratification | stratification | stratification |
| 2.5 | h | No | No | No | No | No |
| | | stratification | stratification | stratification | stratification | stratification |
| 3 | h | No | Nc | No | No | No |
| | | stratification | stratification | stratification | stratification | stratification |

TABLE 3
Application Performance Test of Water-Soluble Epoxy Resin Carbon Fiber Sizing Agent

| | | Embodiment | Embodiment | Embodiment | Embodiment | Embodiment |
|---|---|---|---|---|---|---|
| | Unsized | 1 | 2 | 3 | 4 | 5 |
| Spread Width | 20 | 120 | 100 | 80 | 150 | 130 |
| (%) | | | | | | |
| Composite | 3.52 | 3.81 | 3.78 | 3.65 | 3.95 | 3.73 |
| Tensile | | | | | | |
| Strength | | | | | | |
| (Gigapascal, | | | | | | |
| abbreviated as | | | | | | |
| GPa) | | | | | | |

According to Table 3, comparing carbon fiber tows sized with the above embodiments to unsized tows, it is found that the spread width of the sized carbon fiber tows is significantly increased. This performance indicator can significantly improve the dispersion ability of carbon fiber tows in the resin. The improved dispersion ability also allows for better bonding between the carbon fibers and the resin, thereby notably increasing the tensile strength of the composite material. The tensile strengths of the obtained composite materials are all significantly higher than the 3.52 GPa of the unsized tow.

In FIG. 1, line a is the infrared spectrum of polyethylene glycol 2000, line b is the infrared spectrum of the formulated epoxy resin mixture from the embodiment 2, and line c is the infrared spectrum of the modified epoxy resin sizing/film-forming agent emulsion sample obtained in the embodiment 2. As shown in FIG. 1, the strong, broad absorption peak at 3371 cm⁻¹ in line the a corresponds to the —OH stretching vibration of polyethylene glycol. The strong, broad absorption peak at 3478 cm⁻¹ in the line b corresponds to the —OH stretching vibration of the epoxy resin. However, this peak position significantly disappears in the line c, indicating that the —OH groups are consumed in the reaction. The absorption shoulder peaks at 2865 cm⁻¹ in the line a and 2965 cm⁻¹ in the line b correspond to stretching vibrations of —CH₃ groups, appearing as a weak absorption peak at 2858 cm⁻¹ in the line c. The strong, sharp absorption peaks at 2358 cm⁻¹ in the line a and in the 2088 cm⁻¹-1885 cm⁻¹ range in the line b correspond to bending vibrations of —CH₂, which clearly disappear in the line c, indicating good incorporation of —CH₂ bonds in the sample. The strong absorption peak at 1112 cm⁻¹ in the line a, attributed to C—O—C stretching vibration, appears as a weak absorption peak at 1092 cm⁻¹ in the line c with a shifted position. The strong absorption peak at 1032 cm⁻¹ in the line b is generated by the terminal epoxy groups, appearing as a weak absorption peak at 1092 cm⁻¹ in the line c. These characteristic peaks indicate the presence of reaction products between polyethylene glycol and epoxy resin in the sample, meaning the product retains both hydrophilic alcohol hydroxyl groups and hydrophobic epoxy groups.

FIG. 3 is an SEM photograph of the carbon fiber surface after sizing with the sizing agent from the embodiment 1. It can be seen that at a magnification of 2500×, the carbon fiber surface shows some shallow grooves, distributed relatively uniformly. A layer of sizing agent is clearly attached and evenly distributed. After sizing with the agent from the embodiment 1, it can be observed that the carbon fiber filaments disperse well without the appearance of fuzz.

### Comparative Embodiment 1

Polyethylene glycol 2000 is weighed and subjected to vacuum distillation in a rotary evaporator to completely remove water molecules from the polyethylene glycol. Phthalic anhydride and polyethylene glycol are weighed in a molar ratio of 1:2.8 and then mixed to obtain a mixture. This mixture is added, under pH=5.0 conditions, into a four-neck separable glass reaction vessel equipped with a thermometer, a stirrer, a condenser for reflux, and a nitrogen inlet for protection, to perform modification and grafting of the polyethylene glycol. The reaction temperature is 110° C., and the reaction time is 4 hours.

Epoxy resins 6004 and E414 are blended in a mass ratio of 3:1. Based on an epoxy equivalent weight of 185 for 6004 and an epoxy equivalent weight of 220 for E414, the calculated epoxy equivalent weight of the formulated epoxy resin mixture is 194. The prepared phthalic anhydride-modified polyethylene glycol and the formulated epoxy resin mixture are combined in a molar ratio of 1:1.2. At 120° C., 0.1 g of potassium persulfate is added, and the reaction is carried out under nitrogen protection for 3.5 hours to obtain a sizing agent.

After emulsification, the obtained sizing agent has a particle size of 273 nm and a Zeta potential of −13.25 mV. Clear sedimentation is observed after standing for 45 days. Compared with the embodiment 5, the main issue is the relatively higher proportion of polyethylene glycol during the preparation of the phthalic anhydride-modified polyethylene glycol. This results in an excess of unmodified polyethylene glycol reacting with the epoxy resin, leading to more bis-epoxy groups reacting with polyethylene glycol. This reduces the number of segments with self-emulsifying functionality and also results in larger polymerized chain segments, thereby decreasing its stability.

### Comparative Embodiment 2

Polyethylene glycol 4000 is weighed and subjected to vacuum distillation in a rotary evaporator to completely remove water molecules from the polyethylene glycol. Phthalic anhydride and polyethylene glycol are weighed in a molar ratio of 1:1.5 and then mixed to obtain a mixture. This mixture is added, under pH-3.0 conditions, into a four-neck separable glass reaction vessel equipped with a thermometer, a stirrer, a condenser for reflux, and a nitrogen inlet for protection, to perform modification and grafting of the polyethylene glycol. The reaction temperature is 140° C., and the reaction time is 2 hours.

Epoxy resins E51 and E44 are blended in a mass ratio of 1:2. Based on an epoxy equivalent weight of 190 for E51 and an epoxy equivalent weight of 175 for E44, the calculated epoxy equivalent weight of the formulated epoxy resin mixture is 180. The prepared phthalic anhydride-modified polyethylene glycol and the formulated epoxy resin mixture are combined in a molar ratio of 1:0.6. At 140° C., 0.1 g of potassium persulfate is added, and the reaction is carried out under nitrogen protection for 4 hours to obtain a sizing agent.

After emulsification, the obtained sizing agent has a particle size of 170 nm and a Zeta potential of −5.24 mV. Clear sedimentation is observed after standing for 45 days. Compared with the embodiment 3, the main issue is the relatively lower proportion of polyethylene glycol during the preparation of the phthalic anhydride-modified polyethylene glycol. After reaction with the epoxy resin, the amount of modified polyethylene glycol is significantly insufficient, preventing full reaction between the epoxy groups and polyethylene glycol. This reduces the number of segments with self-emulsifying functionality, resulting in a lower charge carried by the obtained water-soluble epoxy resin carbon fiber sizing agent and thereby decreasing its stability.

The various embodiments in this specification are described in a progressive manner, with each embodiment focusing on differences from other embodiments. Similar or identical parts between embodiments can be referred to mutually. For the schemes disclosed in the embodiments, since they correspond to the methods disclosed in the embodiments, the description is relatively brief. For relevant parts, reference can be made to the description in the method section.

The foregoing description of the disclosed embodiments is provided to enable any person skilled in the art to make or use the disclosure. Various modifications to these embodiments will be readily apparent to those skilled in the art, and the generic principles defined herein may be applied to other embodiments without departing from the spirit or scope of the disclosure. Thus, the disclosure is not intended to be limited to the embodiments shown herein but is to be accorded the widest scope consistent with the principles and novel features disclosed herein.

What is claimed is:

1. A method for preparing a water-soluble epoxy resin carbon fiber sizing agent, comprising the following steps:
(1) subjecting polyethylene glycol to vacuum distillation in a rotary evaporator to remove water molecules to obtain dehydrated polyethylene glycol;
(2) adding the dehydrated polyethylene glycol and phthalic anhydride into a reaction vessel, performing modification and grafting on the dehydrated polyethylene glycol in an acidic environment under stirring with condensate reflux, and introducing nitrogen for protection, thereby obtaining phthalic anhydride-modified polyethylene glycol;
(3) blending two different epoxy resins, calculating an epoxy equivalent weight to obtain a formulated epoxy resin mixture; and
(4) performing a grafting reaction between the phthalic anhydride-modified polyethylene glycol and the formulated epoxy resin mixture under an action of a catalyst, thereby obtaining the water-soluble epoxy resin carbon fiber sizing agent with a self-emulsifying capability.

2. The method for preparing the water-soluble epoxy resin carbon fiber sizing agent as claimed in claim 1, wherein in step (1), the polyethylene glycol has a molecular weight in a range of 1000-4000.

3. The method for preparing the water-soluble epoxy resin carbon fiber sizing agent as claimed in claim 1, wherein in step (2), a molar ratio of the phthalic anhydride to the polyethylene glycol is 1:(1.6-2.4).

4. The method for preparing the water-soluble epoxy resin carbon fiber sizing agent as claimed in claim 1, wherein in step (2), the acidic environment has a pH in a range of 3-5; and a speed of the stirring is in a range of 180-300 revolutions per minute (r/min).

5. The method for preparing the water-soluble epoxy resin carbon fiber sizing agent as claimed in claim 1, wherein in step (2), a reaction temperature of the modification and grafting is in a range of 105-140° C. and a reaction time of the modification and grafting is in a range of 2-4 hours.

6. The method for preparing the water-soluble epoxy resin carbon fiber sizing agent as claimed in claim 1, wherein in step (3), the epoxy resins comprise E51, E44, 6004, and E414.

7. The method for preparing the water-soluble epoxy resin carbon fiber sizing agent as claimed in claim 1, wherein in step (3), the formulated epoxy resin mixture has an epoxy equivalent weight in a range of 180-210.

8. The method for preparing the water-soluble epoxy resin carbon fiber sizing agent as claimed in claim 1, wherein in step (4), a molar ratio of the phthalic anhydride-modified polyethylene glycol to the formulated epoxy resin mixture is in a range of 1:(0.6-1.4).

9. The method for preparing the water-soluble epoxy resin carbon fiber sizing agent as claimed in claim 1, wherein in step (4), the catalyst is one selected from potassium persulfate and ammonium persulfate.

10. The method for preparing the water-soluble epoxy resin carbon fiber sizing agent as claimed in claim 1, wherein in step (4), a reaction temperature of the grafting reaction is in a range of 110-140° C. and a reaction time of the grafting reaction is in a range of 2-5 hours.
